(19) United States
(12) Patent Application Publication
(10) Pub. No.: US 2015/0135471 A1
(43) Pub. Date: May 21, 2015

(54) CENTRAL VACUUM CLEANER WITH SWITCHED-MODE POWER SUPPLY

(71) Applicant: Cube Investments Limited, Aurora (CA)

(72) Inventor: James Vern CUNNINGHAM, Aurora (CA)

(21) Appl. No.: 14/547,775

(22) Filed: Nov. 19, 2014

Related U.S. Application Data
(60) Provisional application No. 61/906,540, filed on Nov. 20, 2013.

(51) Int. Cl. A47L 5/38; A47L 9/28; H02K 17/04

(52) U.S. Cl. CPC A47L 5/38; H02K 17/04; A47L 9/2831; A47L 9/2842
USPC 15/301; 318/767

(57) ABSTRACT

A circuit for controlling a motor of a central vacuum system, the motor being configured to operate using an alternating current is disclosed. The circuit includes an alternating current input for receiving the alternating current; a switched-mode power supply (SMPS) for converting the alternating current to a direct current, the SMPS having an alternating current input terminal and a direct current output terminal; and a control switch coupled to the direct current output terminal, wherein only when the control switch is closed is the alternating current received at the motor.

### FIELD

This disclosure relates to a central vacuum cleaning system, in particular to a central vacuum cleaning system having a control circuit using a switched-mode power supply.

### BACKGROUND

A central vacuum cleaning system often has a vacuum motor placed in an isolated area of a building, such as a garage, basement, mechanical room, or other room. The motor is isolated, thereby reducing the noise from the motor in the living areas of the building; thus a more powerful motor may be used. However, the isolated motor is also less accessible to a user; thus more difficult to control. Various control systems can be used to control the central vacuum system.

### SUMMARY

In one aspect of the disclosure, a circuit for controlling an alternating current motor of a central vacuum system is disclosed. The circuit includes an alternating current input for receiving the alternating current; a wide input voltage range switched-mode power supply (SMPS) for converting the alternating current to a direct current, the SMPS having an alternating current input terminal and a direct current output terminal; and a control switch coupled to the direct current output terminal, wherein only when the control switch is closed is the alternating current received at the motor.

In one aspect of the disclosure, the circuit also includes a relay coupled to the control switch and to the motor, such that when the control switch is closed the relay is energized and connects the motor to the alternating current. The circuit may also include a sensor, an indicator and a controller for receiving information from the sensor and providing an indication on the indicator in correspondence with the information. Each of the sensor, the indicator, the controller and the control switch may be connected in parallel to the direct current output terminal of the SMPS.

In another aspect of the disclosure, the circuit also includes a TRIAC coupled to the motor for controlling the alternating current received at the motor; and a controller coupled to the control switch. The controller is configured to send a signal to the TRIAC to allow the alternating current to flow to the motor when the control switch is closed. The circuit may also include a potentiometer to allow for a plurality of motor control speed settings coupled to the controller. The signal to the TRIAC indicates a selected motor control setting, and the TRIAC controls the flow of alternating current to the motor in dependence on the signal to the TRIAC. The circuit may also include a sensor and an indicator, wherein the controller is configured for receiving information from the sensor and providing an indication on the indicator in correspondence with the information. The controller may be configured to control the motor in dependence on the received information from the sensor. Each of the sensor, the indicator, the controller and the control switch may be connected in parallel to the direct current output terminal of the SMPS. The control switch, the potentiometer and the direct current output terminal of the SMPS may be connected in series to one another.

In another aspect of the disclosure, a central vacuum system is disclosed, including a motor coupled to an alternating power source; a conduit defining an airflow path to the motor; and a circuit for controlling the motor.

According to one aspect there is provided a method of controlling application of power to a motor of a central vacuum cleaning system comprising: receiving an AC power signal at a switched-mode power supply (SMPS);providing a DC power signal from the SMPS to a switch; and monitoring for switching of the switch into or out of a predetermined state and causing the AC power signal to be supplied to operate the motor of the central vacuum cleaning system when the switch is switched into the predetermined state and casing the AC power signal to cease being supplied to operate the motor when the switch is switched out of the predetermined state.

### BRIEF DESCRIPTION OF THE DRAWINGS

Reference will now be made, by way of example, to the accompanying drawings which show example embodiments of the present application, and in which:

FIG. 1 shows a cross-section of a building incorporating a central vacuum system;

FIG. 2A shows in block-diagram form a first example circuit for use with the central vacuum system of FIG. 1; and

FIG. 2B shows in block-diagram form a second example circuit for use with the central vacuum system of FIG. 1.

Similar reference numerals may have been used in different figures to denote similar components.

### DESCRIPTION OF EXAMPLE EMBODIMENTS

A control subsystem for controlling a central vacuum cleaning system is disclosed. The control subsystem is an “always-on” control subsystem; thus requiring a constant supply of electrical power. The control subsystem allows for convenient remote control of the central vacuum cleaning system, as an operator does not need to switch the system on from an isolated area in the building. Additionally, the control subsystem provides for optional continuous monitoring of the building for added safety.

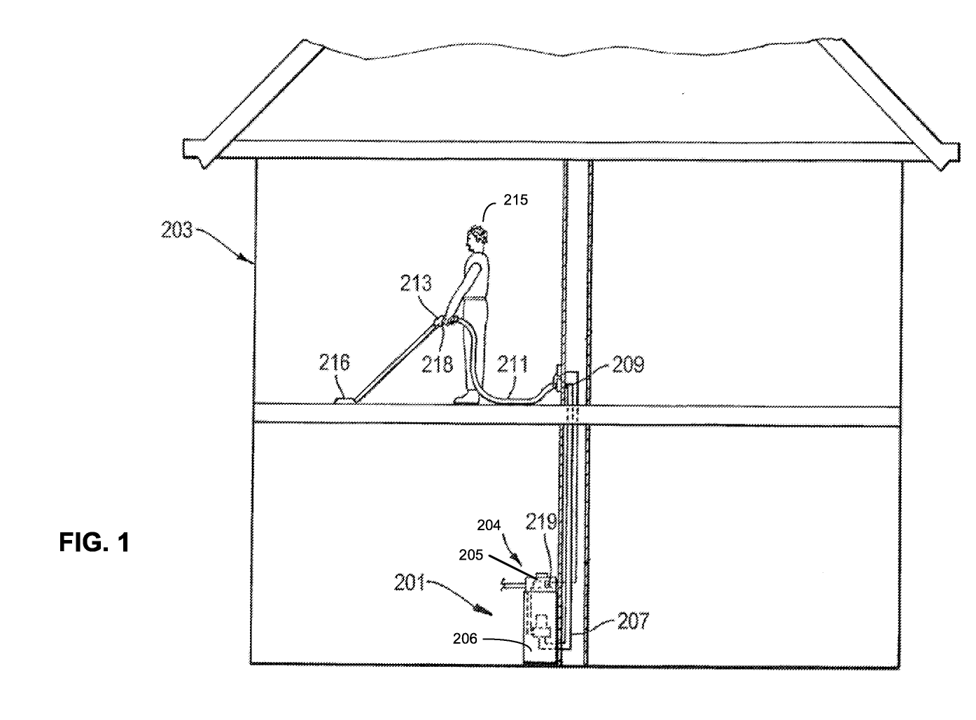

Referring to FIG. 1, a central vacuum cleaning system 201 incorporating a control subsystem 219 will be further described. The system 201 is installed in a building 203. The building 203 is shown as a residence; however, the system 201 could be installed in other buildings, such as commercial or industrial buildings.

The system 201 has a central vacuum unit 204 in an isolated location which houses a vacuum motor 205 and includes a dirt receptacle or canister 206. The vacuum unit 204 is connected through pipes 207, or other conduits in walls, floors or ceilings of the building 203, which define an airflow path to the unit 204. Alternatively, the pipes 207 may be exposed. During operation, the vacuum motor 205 generates suction through the pipes 207 to draw cleaning air through the canister 206. The pipes 207 terminate at valves 209 throughout the building 203 to which a flexible hose 211 may be connected. The hose 211 terminates in a handle 213 that is held by an operator 215. Various cleaning attachments, such as a carpet brush 216, are connected to the handle 213.

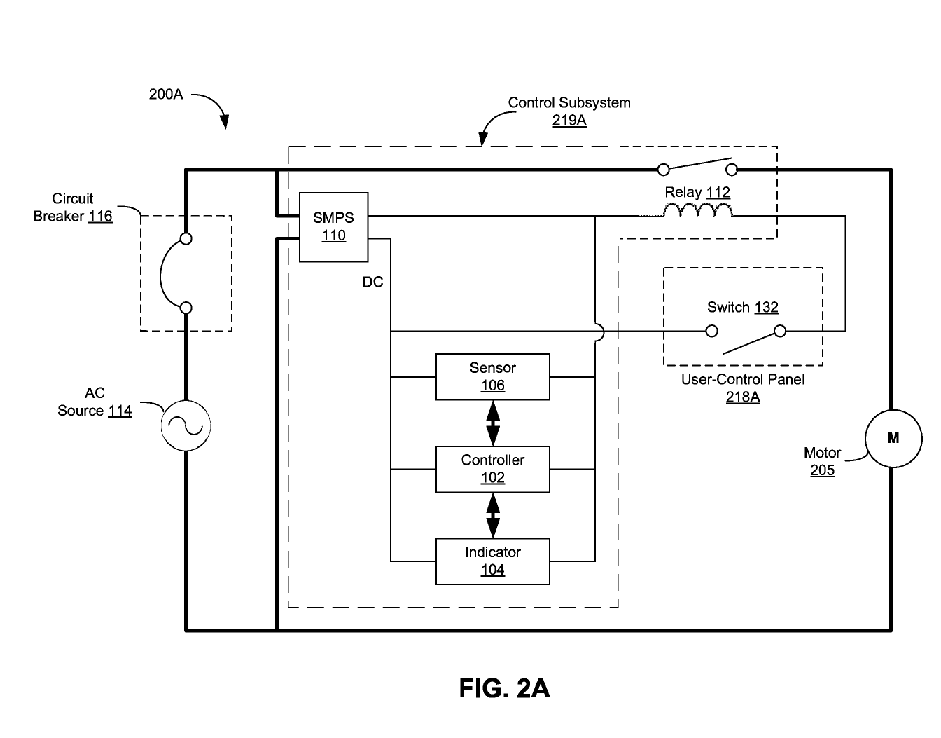

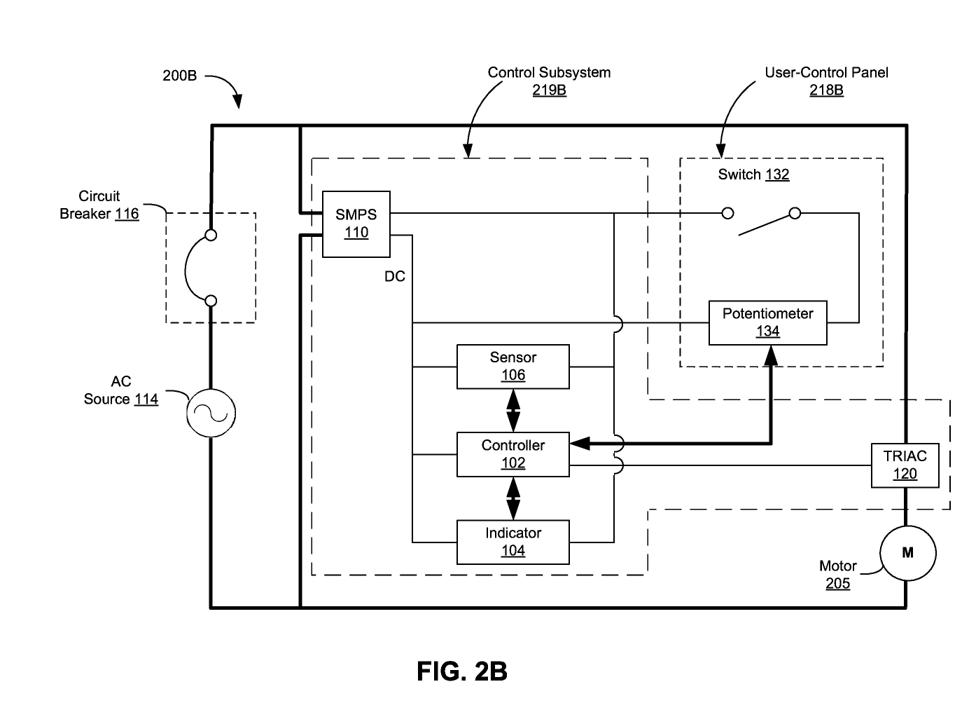

The motor 205 is coupled to an alternating current (AC) source 114 (shown in FIGS. 2A and 2B). To provide sufficient power to generate an effective vacuum, the motor 205 is configured to operate using a high power source, typically from an electrical outlet providing an alternating current (AC) source. The output of electrical current from the electrical outlet is typically in the 5-30 A range at a voltage in the 100-240V (root mean square voltage) range having a frequency of 50-60 Hz. It is thus apparent that the electrical current needed to operate the motor 205 is at an unsafe level for the operator 215.

A control subsystem 219 is thus used to electrically isolate the operator 215 from the motor 205. Control signals, such as ON/OFF, from the operator 215 are provided through a user-control panel 218, typically provided in the handle 213, communicating the control subsystem 219 (example embodiments of the control subsystem 219, 219A and 219B are provided in FIGS. 2A and 2B respectively). The control subsystem 219 is typically located near the motor 205, as illustrated. When the operator 215 turns on the system 201, dirt is drawn by a vacuum created by the motor 205 through the attachment 216, handle 213, hose 211, and pipes 207, and into canister 206.

The user-control panel 218 (example embodiments of the user-control panel 218, 218A and 218B are provided in FIGS. 2A and 2B respectively) is included in the system 201 to allow the operator 215 to interface with the control subsystem 219 safely and conveniently. The user-control panel 218 is this desirably located at a convenient location for the operator 215, such as in the handle 213. The user-control panel 218 is electrically coupled to the control subsystem 219 via electrical lines (not-shown), for example in the handle 213, the hose 211, the valves 209 and the pipes 207. In some embodiments, the electrical lines run through the handle 213 and the hose 209 and interface with electrical terminals in the valves 209 when the hose 209 is connected to the valves 209. The electrical lines in the pipes 207 may be included on an outer edge of the pipes 207 or may be internal to the pipes 207. Typically only two electrical lines are used between the user-control panel 218 and the control subsystem 219, providing positive and negative terminals for both power and communication signals. Addition electrical lines may also be added.

Reference is now made to FIG. 2A, showing, in block-diagram form, an example circuit 200A for use with the central vacuum cleaning system 201. The circuit 200A includes a control subsystem 219A, a user-control panel 218A, the motor 205, an AC source 114 (i.e. an electrical outlet) and a circuit breaker 116. The AC source 114 is coupled to the circuit breaker 116 for added safety, and to the motor 205 to provide AC power to the motor. The circuit 200A provides AC power to the motor 205, DC power to the control subsystem 219A and the user-control panel 218A. The motor 205 is under direct control of the control subsystem 219A and under indirect control of the user-control panel 218A, as will be explained.

The control subsystem 219A is electrically coupled to the AC source 114, the motor 205 and the user-control panel 218A. The control subsystem 219A receives control signals from the user-control panel 218A and controls the motor 205 in accordance with the received control signals. To protect the operator 215 from the high-power electrical energy of the AC source 114, the control subsystem 219A receives the high-power alternating current of the AC source 114 and converts the alternating current to a low-power direct-current (DC). The operator only interfaces with the user-control panel 218A, which is only coupled to the DC power. The DC current is typically in the 1,000-42 mA (milliamp) range, at a voltage of 3-24V (DC volts). The DC power is thus safer for the operator 215 to handle than the AC power.

The control subsystem 219A includes a switched-mode power supply (SMPS) 110 for converting alternating current to direct current, a relay 112 and optionally, a controller 102, one or more sensors 106, and one or more indicators 104. In some embodiments, the SMPS 110 is a wide input voltage range SMPS. In some embodiments, the components or some of the components of the control subsystem 219A are coupled to a printed circuit board (PCB) having electrical traces. The components are electrically coupled to one another using the electrical traces of the PCB or alternatively using wires. The SMPS 110 has alternating current input terminals for receiving AC power from the AC source 114 and direct current output terminals for outputting DC power to the user-control panel 218A, the controller 102, the sensor 106 and the indicator 104.

The SMPS 110 rectifies the AC power input to DC power (i.e. converts AC power to DC power). During power conversion, the SMPS 110 switches between “on” and “off” states, but dissipates power mainly during “on” states; thereby providing for a more efficient power conversion. In the central vacuum cleaning system 201, the control subsystem 219 is ideally always powered for greater convenience to the operator 215; allowing the operator to control the motor 205 at any time without requiring the operator to be in the same physical location as the motor 205. The enhanced efficiency in power conversion thus allows for convenience in controlling the motor 205, but at lower electrical costs.

An example of a SMPS 110 employed in the control subsystem 219A is a single output SMPS, having part-number ZP01S and provided by ZETTLER Magnetics®, receiving an alternating power input having an AC voltage in the range of 90-264 V, oscillating at 47-63 Hz with a maximum current input of 25 A, and providing a one Watt power output having a DC voltage in the range of 3.3-24V at a current level in the range of 300-42 mA. Another example of a SMPS 110 employed in the control subsystem 219A is a single output SMPS, having part-number ZP03S and provided by ZETTLER Magnetics®, receiving an alternating power input having an AC voltage in the range of 90-264V, oscillating at 47-63 Hz with a maximum current input of 25 A, and providing a three Watt power output having a DC voltage in the range of 3.3-24V at a current level in the range of 900-125 mA. Although specific examples of SMPSs have been provided, any number of suitable solid-state, low power consuming SMPS devices could be used to implement SMPS 110.

The user-control panel 218A includes a switch 132, and is electrically connected in series with a relay 112 in the control subsystem 219A. The switch 132 is coupled to the DC output terminals of the SMPS 110 and the relay 122. The relay 112 is coupled to the DC output terminals, the switch 132, the AC source 114 and the motor 205. When the switch 132 is closed, for example by the operator 215, the relay 112 is energized and closes the circuit providing the AC power to the motor 205, thereby connecting the motor 205 to the AC source 114 and turning on the motor. When the switch 132 is opened by the operator 215, the relay 112 opens the circuit providing the AC power to the motor 205, thereby disconnecting the motor 205 from the AC source 114 and turning off the motor.

Optionally connected in parallel to the DC output terminals of the SMPS 110, and in parallel to the switch 132 and the relay 112, and in parallel to one another are controller 102, sensor(s) 106 and indicator(s) 104. The controller 102 may include a microprocessor or a field-programmable gate array (FPGA) circuit, which receives and sends communication and control signals to and from the sensor 106 and the indicator 104. The controller 102 may include a clock for synchronizing communications and operations of the sensor 106 and the indicator 104. The controller 102 is typically centrally located near the motor 205 at the central vacuum unit 204.

One or more sensors 106 may be positioned at the handle 213, in the pipes 207, in the hose 211, or the valves 209, and may communicate with the controller 102 via a serial communication protocol over the electrical lines used for powering the user-control panel 218A. Serial communication protocols can be implemented using one electrical wire (such as 1-Wire®), or using two electrical wires (such as I²C®); thus no additional electrical lines are needed. Additionally, one or more sensors 106 may be positioned at central vacuum unit 204 and may communicate with the controller 102 via the same serial communication protocols, however; due to their proximity to the motor 205, other more complex communication protocols requiring more communication lines (e.g. RS 232, using three or five wires) can also be implemented to provide faster and less error prone communication. The sensors 106 include, without limitation, any one of: (1) an oxygen sensor, (2) an air contaminant sensor, measuring the level or dust and other particles in the air, (3) an airflow sensor, measuring airflow through the pipes 207, and (4) a dust level sensor, measuring the level of dust in a dust storage area coupled to the motor.

The controller 102 receives information from the sensor(s) 106, processes the information, and provides a signal to one or more indicators 104 to provide an indication to the operator 215 (or other person) in correspondence with this information. One or more indicators 104 may be positioned at the handle 213 or at the central vacuum unit 204, and may receive communication and control signals from the controller 102 via the same protocols used for sensor communication. The indicators 104 include, without limitation, any one of: (1) a display, (2) one or more light-emitting diodes (LED), including multi-color LEDs, where each color represents a sensor state, and (3) a speaker.

In some embodiments, the controller 102, the one or more sensors 106 and the one or more indicators 104 are only active when the motor 205 is active, while in other embodiments they are active at all times. Continuous operation of the controller 102, the sensors 106 and the indicators 104 helps improve the safety levels associated with the system 201. For example, continuous monitoring can be performed to determine if the level of contaminants in the air in the building 203 is at an unsafe level due to the vacuuming process unsettling contaminants and releasing the contaminants into the air (or other reasons unrelated to vacuuming), thus putting any person in the building 203 is at risk. In such as case an audible warning is ideally provided through an indicator 104 until the level of contaminants in the air is at a safe level. Thus, continuous operation of the controller 102, sensors 106 and indicators 104 is desired. In example embodiments, the SMPS 110 efficiently provides a constant DC power supply to the sensors 106, controller 102, and the indicators 104 even when relay 112 is open; thereby allowing for efficient continuous operation of the sensors 106 and indicators 104.

Reference is now made to FIG. 2B, showing, in block-diagram form, an example circuit 200B for use with the central vacuum cleaning system 201. The circuit 200B includes a control subsystem 219B, a user-control panel 218B, the motor 205, the AC source 114 and the circuit breaker 116. The circuit 200B provides AC power to the motor 205, DC power to the control subsystem 219B and the user-control panel 218B. The motor 205 is under direct control of the control subsystem 219B and under indirect control of the user-control panel 218B.

The control subsystem 219B is electrically coupled to the AC source 114, the motor 205 and the user-control panel 218B. The control subsystem 219B receives control signals from the user-control panel 218B and controls the motor 205 in accordance with the received control signals. To protect the operator 215 from the high-power electrical energy of the AC source 114, the control subsystem 219B receives the high-power alternating current of the AC source 114 and converts the alternating current to a low-power direct-current (DC). The operator only interfaces with the user-control panel 218B, which is only coupled to the DC power.

The control subsystem 219B includes a SMPS 110 for converting alternating current to direct current, a controller 102, a triode for alternating current (TRIAC) 120 and optionally, one or more sensors 106, and one or more indicators 104. In some embodiments, the components or some of the components of the control subsystem 219B are coupled to a printed circuit board (PCB) having electrical traces. The components are electrically coupled to one another using the electrical traces of the PCB or alternatively using wires. The SMPS 110 has alternating current input terminals for receiving AC power from the AC source 114 and direct current output terminals for outputting DC power to the user-control panel 218B, the controller 102, the sensor 106 and the indicator 104. The SMPS 110 of FIG. 2B functions similarly to the SMPS 110 of FIG. 2A.

The TRIAC 120 includes a gate, and two anodes. The TRIAC 120 conducts current between the two anodes. The amount of current allowed to flow through the anodes is variable in dependence on the input at the gate. The anodes of the TRIAC 120 are connected in series to the motor 205; therefore, the TRIAC 120 controls the amount of current allowed to flow to the motor 205, in dependence on the input at the gate. The speed of the motor 205 varies in dependence on the amount of current at the motor 205. The controller 102 is electrically coupled to the gate; thereby the controller 102 is able to control the speed of the motor 205 by varying the input at the gate. The output signal from the controller 102 is typically a digital signal, thus a digital-to-analogue convertor (DAC) may be used to convert the output signal to an analogue signal to interface with the gate of the TRIAC 120.

The user-control panel 218B includes a switch 132 and optionally a potentiometer 134 electrically connected in series with one another and to the DC output terminals of the SMPS 110. When the switch 132 is closed, for example by the operator 215, the controller 102 instructs the TRIAC 120 to close the circuit providing the AC power to the motor 205, thereby connecting the motor 205 to the AC source 114 and turning on the motor. When the switch 132 is opened by the operator 215, the controller 102 instructs the TRIAC 120 to open the circuit providing the AC power to the motor 205, thereby disconnecting the motor 205 from the AC source 114 and turning off the motor.

The potentiometer 134 allows the operator 215 to select a motor control setting for the motor 205 from several motor control settings. The motor control settings may include, without limitation settings for varying the speed of the motor 205. The potentiometer 134 is communicatively coupled to the controller 102, and may communicate with the controller 102 via a serial communication protocol over the electrical lines used for powering the user-control panel 218B. In some embodiments, the potentiometer 134 includes a knob that adjusts a variable resistor electrically coupled in series to the switch 132; thereby varying the DC voltage at the potentiometer 134. The potentiometer also includes an analogue-to-digital convertor (ADC) for converting the DC voltage at the potentiometer 134 to a digital value, and a transmitter for sending the digital value to the controller 102. In other embodiments, a digital potentiometer is used, and may include several push buttons, each selecting a speed of the motor (for example, “low”, “medium” and “fast” speed settings). The controller 102 will adjust the speed of the motor 205 in correspondence with the selected setting of the potentiometer 134 by sending a signal to the TRIAC 120 corresponding to the selected setting.

Optionally connected in parallel to the DC output terminals of the SMPS 110, and in parallel to the switch 132 and the potentiometer 134, and in parallel to the controller 102, and in parallel to one another are one or more sensors 106 and one or more sensors indicators 104. The controller 102, the sensors 106 and the indicators 104 of the control subsystem 219B function similarly to the controller, sensors and indicators of the control subsystem 219A in providing information to the operator 215. However, in some embodiments, in addition to providing information to the operator 215, the sensors 106 and the controller 102 of the control subsystem 219B are also used to control the speed of the motor 205, via the TRIAC 120.

In one embodiment, the handle 213 is equipped with an orientation sensor such as an accelerometer sensor. The accelerometer sends real-time data to the controller 102 when the motor 205 is turned on. The controller 102 is configured to analyze the accelerometer data and in particular to detect when the data is indicative of the operator 215 lifting the handle 213 in an upwardly direction; indicating that the cleaning attachment 216 is no longer touching the ground. At that point in time, the motor 205 is active, thereby consuming electrical power, but does not provide any useful result; as the cleaning attachment 216 is off the ground. The controller 102 therefore upon detecting that the cleaning attachment 216 is no longer touching the ground reduces the speed of the motor 205, or turns off the motor 205. The controller 102 then analyzes the accelerometer data to detect when the data is indicative of the operator 215 lifting the handle 213 in a downwardly direction; indicating that the cleaning attachment 216 is touching the ground. When the controller 102 detects the handle 213 is moved in a downwardly direction, the controller 102 then returns the motor 205 to the selected speed setting.

In another embodiment, a proximity sensor is installed in the cleaning attachment 216, to detect when the cleaning attachment 216 is touching the ground. The speed of the motor 205 is then varied by the controller in dependence on the input the proximity sensor to help reduce power consumption by the motor 205.

In another embodiment, an air contaminant sensor is used to determine if the level of contaminants in the air in the building 203 is at an unsafe level, thus putting any person in the building 203 is at risk. If an unsafe level is detected, the controller 102 (via the TRIAC) turns off the motor 205 and sounds an audible alert.

Certain adaptations and modifications of the described embodiments can be made. Therefore, the above discussed embodiments are considered to be illustrative and not restrictive.

1. A circuit for controlling a motor of a central vacuum system, the motor configured to operate using an alternating current, the circuit comprising:
an alternating current input for receiving the alternating current;
a switched-mode power supply (SMPS) for converting the alternating current to a direct current, the SMPS having an alternating current input terminal and a direct current output terminal; and
a control switch coupled to the direct current output terminal, wherein only when the control switch is closed is the alternating current received at the motor.

2. The circuit of claim 1, further comprising a relay coupled to the control switch and to the motor, wherein when the control switch is closed the relay connects the motor to the alternating current.

3. The circuit of claim 1, further comprising a sensor, an indicator and a controller for receiving information from the sensor and providing an indication on the indicator in correspondence with the information.

4. The circuit of claim 3, wherein each of the sensor, the indicator, the controller and the control switch is connected in parallel to the direct current output terminal of the SMPS.

5. The circuit of claim 1, further comprising:
a TRIAC coupled to the motor for controlling the alternating current received at the motor; and
a controller coupled to the control switch,
wherein the controller is configured to send a signal to the TRIAC to allow the alternating current to flow to the motor when the control switch is closed.

6. The circuit of claim 5, further comprising
a potentiometer having a plurality of motor control settings coupled to the controller,
wherein the signal to the TRIAC indicates a selected motor control setting.

7. The circuit of claim 6, wherein the TRIAC controls the flow of alternating current to the motor in dependence on the signal to the TRIAC.

8. The circuit of claim 5, further comprising a sensor and an indicator, wherein the controller is configured for receiving information from the sensor and providing an indication on the indicator in correspondence with the information.

9. The circuit of claim 8, wherein the controller is configured to control the motor in dependence on the received information from the sensor.

10. The circuit of claim 8, wherein each of the sensor, the indicator, the controller and the control switch is connected in parallel to the direct current output terminal of the SMPS.

11. The circuit of claim 10, wherein the control switch, the potentiometer and the direct current output terminal of the SMPS are connected in series to one another.

12. A central vacuum system comprising:
a motor coupled to an alternating power source;
a conduit defining an airflow path to the motor; and
a circuit for controlling the motor, comprising:
an alternating current input for receiving the alternating current;
a switched-mode power supply (SMPS) for converting the alternating current to a direct current, the SMPS having an alternating current input terminal and a direct current output terminal; and
a control switch coupled to the direct current output terminal, wherein only when the control switch is closed is the alternating current received at the motor.

13. A method of controlling application of power to a motor of a central vacuum cleaning system comprising:
receiving an AC power signal at a switched-mode power supply (SMPS);
providing a DC power signal from the SMPS to a switch; and
monitoring for switching of the switch into or out of a predetermined state and causing the AC power signal to be supplied to operate the motor of the central vacuum cleaning system when the switch is switched into the predetermined state and casing the AC power signal to cease being supplied to operate the motor when the switch is switched out of the predetermined state.

14. The method of claim 13 wherein the switch is located at a handle connected to a vacuum cleaning hose and the motor is located remotely from the handle at a central vacuum unit of the central vacuum cleaning system.
